(19) United States
(12) Patent Application Publication
(10) Pub. No.: US 2014/0129860 A1
(43) Pub. Date: May 8, 2014

(54) METHOD AND APPARATUS FOR ENABLING MOBILE DEVICE POWER MANAGEMENT USING A SHARED WORKER

(71) Applicant: NOKIA CORPORATION, Espoo (FI)

(72) Inventor: Noam Rosenthal, Sunnyvale, CA (US)

(73) Assignee: NOKIA CORPORATION, Espoo (FI)

(21) Appl. No.: 13/669,905

(22) Filed: Nov. 6, 2012

(51) Int. Cl. G06F 1/00

(52) U.S. Cl. 713/323

(57) ABSTRACT

A method, apparatus and computer program product are provided to enable an application in an HTML5 runtime to listen to background servers and wait for events, even if the power savings mode is on. In the context of a method, a share worker application, comprising an event listener, is launched and the operating system is notified not to pause the shared worker application in the power savings mode. In response to a triggering event, the shared worker application may wake up the full system or may wake up only the main execution of JavaScript and a specific action caused by JavaScript while other power savings actions continue. The method may also cause performance of the specific action, such as an audio alert.

### TECHNOLOGICAL FIELD

A method, apparatus and computer program product are provided in accordance with an example embodiment in order to enable an application to listen to background servers and wait for events even if a power saving mode is activated and, more particularly, to cause a mobile device awaken in an instance in which an event is triggered.

### BACKGROUND

Wireless communication is becoming more widespread as a continually increasing number of users acquire and place into operation ever-greater numbers of mobile communication devices. Along with this increase in number of mobile devices there is an increase in the amount of time the mobile devices are in use. This places an ever-increasing demand on the amount of time mobile devices are able to provide functionality between rechargings or repowerings.

The need for longer periods of usability becomes even more apparent as more functionality is incorporated into mobile communication devices. For example, many mobile communication devices now include Personal Information Management (PIM), or a camera, music player (MP3 or the like), or gaming functionality in addition to their communication capabilities. Therefore these devices are potentially in use even when the user is not using the communication capabilities of the device. This additional functionality places further demands on the power reserves of the mobile device.

Currently, one of the most effective methods of conserving power, and thereby extending the amount of time the device can be used, is enabling a power saving mode that turns off the screen of the mobile device and modifies behavior of web applications accordingly. The problem with this approach is that it also reduces the effectiveness of the mobile device. For example, where the device has additional functionality such as listening to a background server, such as when waiting for a calendaring event, this functionality may be disabled when the device enables a power saving mode that pauses webpage JavaScript.

Consequently, a need exists for a method of power management on mobile communication devices that not only reduces the power consumption of the device, but also retains the functionality of the device.

### BRIEF SUMMARY

A method, apparatus and computer program product are provided in accordance with an example embodiment of the present invention in order to enable an application to listen to background servers and wait for events, even if the power savings mode is activated.

In one embodiment, a method is provided that includes executing a first application on a computing device, launching a shared worker application, by the first application. The operating system is informed, by the first application, of power saving mode instructions for the shared worker application, and the shared worker application continues running in accordance with power saving mode instructions when a power savings mode is enabled. The method also causes the shared worker application to send a signal to the operating system comprising wake up instructions, and causes performance of a specific action by the computing device in response to the wake up instructions.

The method of one embodiment may further comprise disabling JavaScript execution in the power saving mode. In another embodiment, the shared worker application may comprise at least one event listener. The method of another embodiment may further comprise turning off a screen of the computing device in the power saving mode.

In another embodiment, the method may further include that the wake up instructions instruct the operating system to return the computing device to a normal operating mode. In yet another embodiment the wake up instructions instruct the operating system to return the first application to a normal operating mode. In yet a further embodiment, the wake up instructions may instruct the operating system to wake up only JavaScript and the specific action.

In another embodiment, an apparatus is provided that includes at least one processor and at least one memory including computer program code with the at least one memory and the computer program code configured to, with the processor, cause the apparatus to execute a first application on a computing device, launch a shared worker application, by the first application. The operating system is informed, by the first application, of power saving mode instructions for the shared worker application, and the shared worker application continues running in accordance with power saving mode instructions when a power savings mode is enabled. In response to a trigger, the apparatus also causes the shared worker application to send a signal to the operating system comprising wake up instructions, and causes performance of a specific action by the computing device in response to the wake up instructions.

The at least one memory and the computer program code may also be configured to, with the processor, cause the apparatus of one embodiment to disable JavaScript execution in the power saving mode. In another embodiment, the shared worker application may comprise at least one event listener. The at least one memory and the computer program code may also be configured to, with the processor, cause the apparatus of one embodiment to turn off a screen of the computing device in the power saving mode.

In another embodiment, an apparatus is provided in which the wake up instructions instruct the operating system to return the computing device to a normal operating mode. In yet another embodiment the wake up instructions instruct the operating system to return the first application to a normal operating mode. In yet a further embodiment, the wake up instructions may instruct the operating system to wake up only JavaScript and the specific action.

In a further embodiment, a computer program product is provided that includes at least one non-transitory computer-readable storage medium having computer-executable program code portions stored therein with the computer-executable program code portions including program code instructions for executing a shared worker application, by the first application. The computer-executable program code portions also include program code instructions for informing the operating system, by the first application, of power saving mode instructions for the shared worker application. The shared worker application continues running in accordance with power saving mode instructions when a power savings mode is enabled. The computer-executable program code portions also include program code instructions for, in response to a trigger, causing the shared worker application to send a signal to the operating system comprising wake up instructions, and for causing performance of a specific action by the computing device in response to the wake up instructions.

The computer-executable program code portions of one embodiment may also include program code instructions for disabling JavaScript execution in the power saving mode. In another embodiment, the shared worker application may comprise at least one event listener. The computer-executable program code portions of one embodiment may also include program code instructions for turning off a screen of the computing device in the power saving mode.

In yet another embodiment, a computer program product is provided wherein the wake up instructions instruct the operating system to return the computing device to a normal operating mode. In yet another embodiment the wake up instructions instruct the operating system to return the first application to a normal operating mode. In yet a further embodiment, the wake up instructions may instruct the operating system to wake up only JavaScript and the specific action.

### BRIEF DESCRIPTION OF THE SEVERAL VIEWS OF THE DRAWINGS

Having thus described certain embodiments of the invention in general terms, reference will now be made to the accompanying drawings, which are not necessarily drawn to scale, and wherein:

FIG. 1 is block diagram of a system that may be specifically configured in accordance with an example embodiment of the present invention;

FIG. 2 is a block diagram of an apparatus that may be specifically configured in accordance with an example embodiment of the present invention;

FIG. 3 is a schematic representation of a system that may support communications, such as browsing activity, between a server and a computing device;

FIG. 4 is flow chart illustrating operations performed, such as by the apparatus of FIG. 2, in accordance with an example embodiment of the present invention;

FIG. 5 is a flow chart illustrating operations performed, such as by the apparatus of FIG. 2, in accordance with an example embodiment of the present invention; and

FIG. 6 is a flow chart illustrating operations performed, such as by the apparatus of FIG. 2, in accordance with an example embodiment of the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

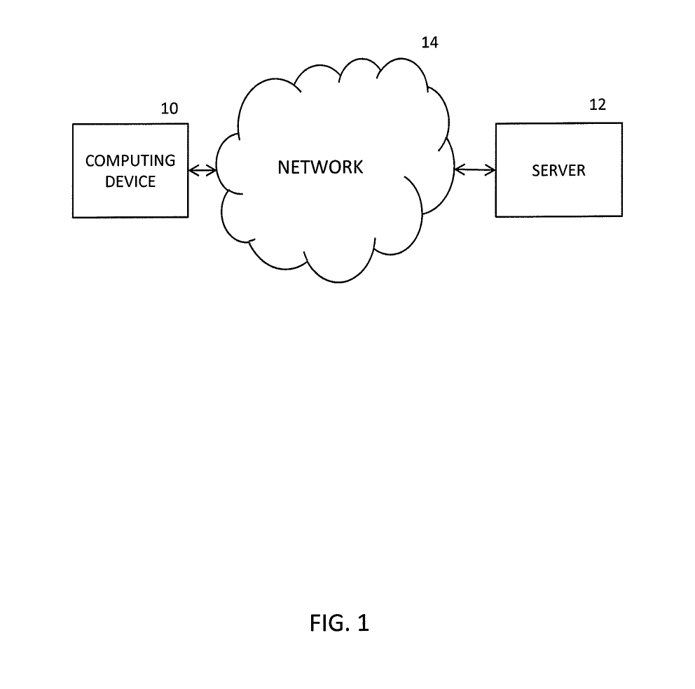

Referring now of FIG. 1, a system that supports communication, either wirelessly or via a wireline, between a computing device 10 and a server 12 or other network entity (hereinafter generically referenced as a “server”) is illustrated. As shown, the computing device and the server may be in communication via a network 14, such as a wide area network, such as a cellular network or the Internet or a local area network. However, the computing device and the server may be in communication in other manners, such as via direct communications between the computing device and the server.

The computing device 10 may be embodied by a number of different devices including mobile computing devices, such as a personal digital assistant (PDA), mobile telephone, smartphone, laptop computer, tablet computer, or any combination of the aforementioned, and other types of voice and text communications systems. Alternatively, the computing device may be a fixed computing device, such as a personal computer, a computer workstation or the like. The server 12 may also be embodied by a computing device and, in one embodiment, is embodied by a web server. Additionally, while the system of FIG. 1 depicts a single server, the server may be comprised of a plurality of servers which may collaborate to support browsing activity conducted by the computing device.

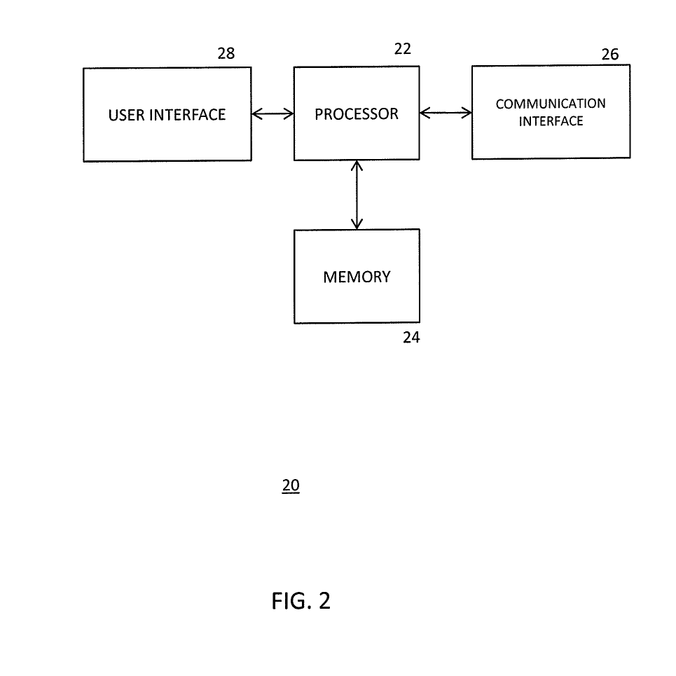

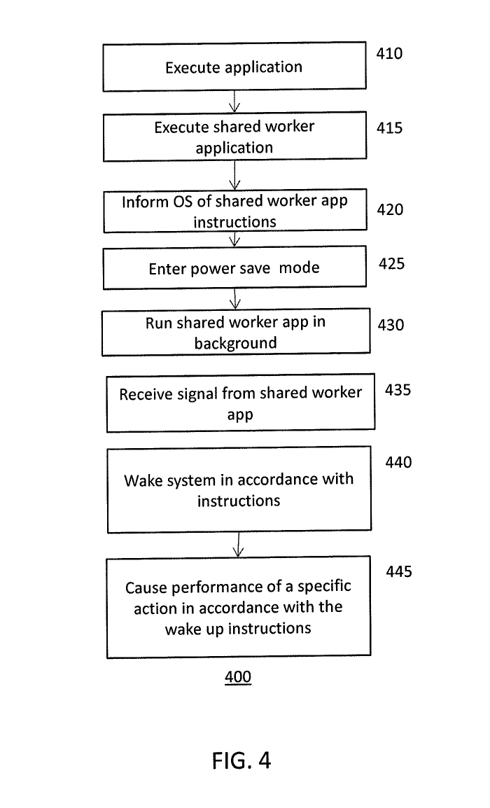

Regardless of the type of device that embodies the computing device 10, the computing device may include or be associated with an apparatus 20 as shown in FIG. 2. In this regard, the apparatus may include or otherwise be in communication with a processor 22, a memory device 24, a communication interface 26 and a user interface 28. It should be noted that while FIG. 4 illustrates one example of a configuration of an apparatus, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

In some embodiments, the processor 22 (and/or co-processors or any other processing circuitry assisting or otherwise associated with the processor) may be in communication with the memory device 24 via a bus for passing infoimation among components of the apparatus. The memory device may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus 20 to carry out various functions in accordance with an example embodiment of the present invention. For example, the memory device could be configured to buffer input data for processing by the processor. Additionally or alternatively, the memory device could be configured to store instructions for execution by the processor.

As noted above, the apparatus 20 may be embodied by a computing device 10 configured to employ an example embodiment of the present invention. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 22 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 22 may be configured to execute instructions stored in the memory device 24 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a head mounted display) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor. In one embodiment, the processor may also include user interface circuitry configured to control at least some functions of one or more elements of the user interface 28.

Meanwhile, the communication interface 26 may be any means such as a device or circuitry embodied in either hardware or a combination of hardware and software that is configured to receive and/or transmit data between the computing device 10 and a server 12. In this regard, the communication interface 26 may include, for example, an antenna (or multiple antennas) and supporting hardware and/or software for enabling communications wirelessly. Additionally or alternatively, the communication interface may include the circuitry for interacting with the antenna(s) to cause transmission of signals via the antenna(s) or to handle receipt of signals received via the antenna(s). For example, the communications interface may be configured to communicate wirelessly with the head mounted displays 10, such as via Wi-Fi, Bluetooth or other wireless communications techniques. In some instances, the communication interface may alternatively or also support wired communication. As such, for example, the communication interface may include a communication modem and/or other hardware/software for supporting communication via cable, digital subscriber line (DSL), universal serial bus (USB) or other mechanisms. For example, the communication interface may be configured to communicate via wired communication with other components of the computing device.

The user interface 28 may be in communication with the processor 22, such as the user interface circuitry, to receive an indication of a user input and/or to provide an audible, visual, mechanical, or other output to a user. As such, the user interface may include, for example, a keyboard, a mouse, a joystick, a display, a touch screen display, a microphone, a speaker, and/or other input/output mechanisms. In some embodiments, a display may refer to display on a screen, on a wall, on glasses (e.g., near-eye-display), in the air, etc. The user interface may also be in communication with the memory 24 and/or the communication interface 26, such as via a bus.

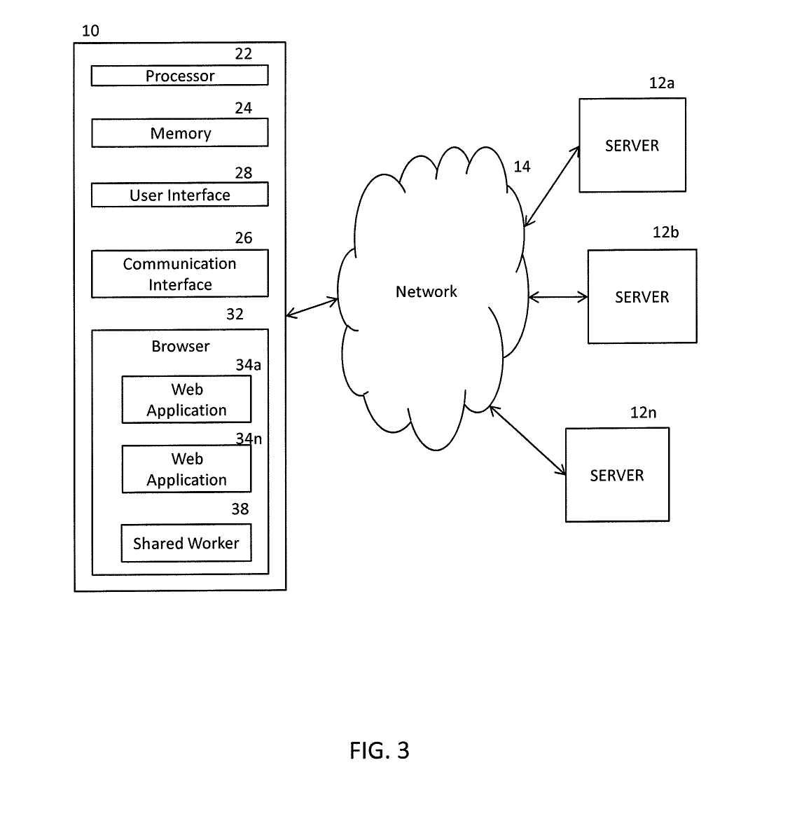

FIG. 3 is block diagram showing one example of a computing system, such as apparatus 20 from FIG. 2, that incorporates a shared worker application 38 consistent with an example embodiment of this disclosure. FIG. 3 shows a local computing device 10 that may be coupled to one or more other computing devices via a network 14. Network 14 may be the Internet. Network 14 may instead be any other network, e.g., a public/private network or a wireless network. Computing device 10 depicted in FIG. 3 may be a mobile communication device, such as a cellular phone. Although not shown in FIG. 3, computing device 10 may be any computing device configured to communicate over a network, for example a desktop computer, a laptop computer, tablet computer, a television, or any other device configured to communicate information via network 14, whether the device's primary purpose is network-based communication or not. Further, computing device 10 may be coupled to network 2 by any number of known mechanisms for network communications, for example wired connections (e.g., Ethernet) or wireless connections (e.g., Wi-Fi, cellular) to network 14.

As depicted in FIG. 3, computing device 10 is coupled to a plurality of network server computing devices 12a-12n via network 14. In order to access information accessible from network servers, 12a-12n, a browser application 32 may run on local computing device 10. Browser 32 may be configured to run within a local operating system of computing device 10. Non-limiting examples of known browser applications include Microsoft Explorer™, Apple Safari™, Mozilla™, Firefox™ and Google Chrome™ browser. Non-limiting examples of known operating systems for desktop and/or laptop computers may include Microsoft Vista™, Apple Snow Leopard™, or Linux. Examples of known operating systems for mobile devices (e.g., smartphones, netbooks, etc.) include Microsoft Windows Mobile®, Apple Iphone OS®, and Google Android™ mobile technology platform.

Browser 32 may enable a user to manipulate access to information accessible via network 14. For example, browser 32 may provide a user with an ability to enter one or more uniform resource indicators (URIs, e.g., www.google.com) in order to access a web application, such as, for example, a hypertext markup language (HTML) document. A web application, and/or information used by a web application, may be stored on one or more network servers 12a-16n. Browser 32 may be configured to access web applications and/or other information stored on network servers 12a-12n for presentation of visual information to a user of computing device 10, among other uses.

As shown in FIG. 3, browser 32 may present, via a window or tab of browser 32, one or more web applications 34a-34n to a user. Only two web applications 34a and 34n are shown in the example of FIG. 3, however, a single web application, or more than two web applications may be presented to a user simultaneously via browser 32. In one example, one or more of web applications 34a-34n are web application configured to present a visual depiction to a user (e.g., an HTML document). One or more of web applications 34a-34n may further present functionality to a user to, for example enable the user to communicate, navigate to other web applications, view a map, view a calendar, play a game, listen to music, watch a video, access (e.g., upload) information local to a user's computing device), or any other form of functionality.

As also shown in FIG. 3, browser 32 includes shared worker 38. In various examples, shared worker 38 is an application or other computer program configured to acquire network accessible information, for example information stored on one or more network servers 12a-12n in the example of FIG. 3, and provide acquired information to one or more web applications 34a-34n. Shared worker application 38 may further be configured to store acquired information in a local memory of a computing device 10, so that shared worker 38 may use the information to satisfy one or more requests for the same or similar information from the one or more web applications 34a-34n. For example, in an instance in which web application 34a has requested certain network accessible information that shared worker 38 acquired in response to the request and stored in local memory, if web application 34n communicates a request for similar information, shared worker may access information stored in local memory to satisfy the request from web application 34n.

A shared worker 38 as described herein may be software executable by a computing device to acquire network accessible information and/or to update sub-component instantiations/visual user interfaces of web applications executed in a browser 32 or other application. In one specific example, shared worker 38 may be one or more independent threads of software (program instructions) written in the JavaScript language. In other examples, shared worker 14 may include software written in any other language.

FIG. 4 shows a flow chart illustrating operations performed, such as by the apparatus 20 of FIG. 2, in accordance with an example embodiment of the present invention. In this regard, a user of the computing device 10 may engage in browsing activity (described hereinafter by way of example, but not of limitation, as one or more web pages) that the user desires to view. The browsing activity may be conducted in various manners including the entry of search queries that may be provided to the server 12 which, in turn, may provide one or more links to web pages that are responsive to the query. The user may then select or actuate one of the links to view the corresponding web page. Alternatively, the browsing activity may be conducted by entering an address, such as a uniform resource locator (URL) that identifies a web page of interest.

As shown in block 410 of FIG. 4, the apparatus 20 embodied by the computing device 10 may therefore be configured to execute an application. The apparatus embodied by the computing device therefore includes means, such as the processor 22, the communication interface 26 or the like, for executing an application. By way of example in which the executed application includes a web application, or any HTML5 or JavaScript™ application or “app”, such as a computer software application that is coded in a browser-supported programming language (such as JavaScript™, combined with a browser-rendered markup language like HTML5, reliant on a common web browser to render the application executable). The opening of a web page or “app” may be performed by a web browser on a user's mobile communications device 10. An HTML5 or JavaScript™ “app” allows web page script to contact a server 12, such as those shown in FIG. 3, items 12a-12n, for storing and retrieving data without the need to re-download an entire web page. In another embodiment of the invention, the application may be a privileged web application or privileged web app. A privileged web app is a piece of web content that may have been verified by, for example, means of an app store or stores or may have obtained or downloaded from a source that is trusted source. A trusted source may provide a privileged web app that may be enabled to override the default power settings.

A specific example in the context of an embodiment of the present invention may be a restaurant app. Once launched on a user's mobile phone, the app may be set to notify a user when the user is nearby. Specifically, the user may be walking or driving to the restaurant and the app may be set to notify the user by means of an audio alert when the user is within 3 miles of the restaurant.

As shown in block 415 of FIG. 4, the apparatus 20 embodied by the computing device 10 may also be configured to execute a shared worker application. Thus, the apparatus may include means, such as the processor 22 or the like, for causing the execution of a shared worker application. In one embodiment of the present invention, the shared worker application may comprise at least one event listener. An event listener is software code that receives a notification when a specific event occurs and may specify an action to take as a result of the event. For example, HTML DOM is a standard way for accessing and manipulating HTML documents. An HTML DOM event, such as an event that occurs when a user clicks a mouse on an element, allows JavaScript to register different event handler functions (i.e. event listeners). Events may be used in combination with even handler functions, and the function and specified action may not be executed before the event occurs, e.g. opening a program when a user clicks a button. In the context of the above example, the restaurant app may launch a shared worker application that listens to location changes based upon information provided, for example, by a position sensor, e.g., a GPS mechanism.

The apparatus 20 embodied by the computing device 10 may also be configured to inform the operating system of power savings mode instructions for the shared worker application. Thus, the apparatus may include means, such as the processor 22 or the like, for causing informing of the operating system of power savings mode instructions for the shared worker application. See block 420 of FIG. 4.

The apparatus 20 embodied by the computing device 10 may also be configured to enter a power saving mode. Thus, the apparatus may include means, such as the processor 22 or the like, for causing the entering of a power savings mode. See block 425 of FIG. 4. In one embodiment, entering a power savings mode may include dimming or darkening of the display of the computing device 10. In another embodiment, entering a power savings mode may include turning off the display of the computing device 10. In another embodiment, the execution of the first application may be suspended or disabled. In the context of the above example, when the user has not touched his mobile device for a period of time, and the mobile device enters a power savings mode, the mobile phone may disable the restaurant app and/or turn off the screen of the mobile phone.

The apparatus 20 embodied by the computing device 10 may also be configured to run the shared worker application in the background in accordance with the power savings mode instructions. Thus, the apparatus may include means, such as the processor 22 or the like, for causing the run the shared worker application in the background in accordance with the power savings mode instructions. See block 430 of FIG. 4. In the context of the above example, the shared worker application continues to run in the background while the mobile phone was in a normal operating mode, when the mobile phone entered a power savings mode, and when the mobile phone is operating in the power savings mode.

The apparatus 20 embodied by the computing device 10 may also be configured to receive a signal from the shared worker application. Thus, the apparatus may include means, such as the processor 22 or the like, for causing the receiving of a signal from the shared worker application. See block 435 of FIG. 4. In the context of the above example, when a GPS mechanism notifies the mobile device of a location change, the event listener of the shared worker application receives the notification and the shared worker application sends a signal to the mobile device.

In response to receiving a signal from the shared worker application, the apparatus 20 embodied by the computing device 10 may also be configured to wake the mobile device 10, the operating system and/or the first application in accordance with a signal received from the shared worker application. Thus, the apparatus may include means, such as the processor 22 or the like, for causing the waking of the mobile device 10, the operating system and/or the first application in accordance with a signal received from the shared worker application. See block 440 of FIG. 4.

Once the mobile device 10, the operating system and/or the first application is operational, the apparatus 20 embodied by the computing device 10 may also be configured to perform a specific action in accordance with the first application or the signal received from the shared worker application. Thus, the apparatus may include means, such as the processor 22 or the like, for causing the performance of a specific action in accordance with the first application or the signal received from the shared worker application after causing the waking of the mobile device 10, the operating system or the first application. See block 445 of FIG. 4. In the context of the above example, the mobile phone may notify the user that the restaurant is within 3 miles by way of an audio alert, the audio alert being instructed from the restaurant app once it was awakened by the system in response to the signal from the shared worker application.

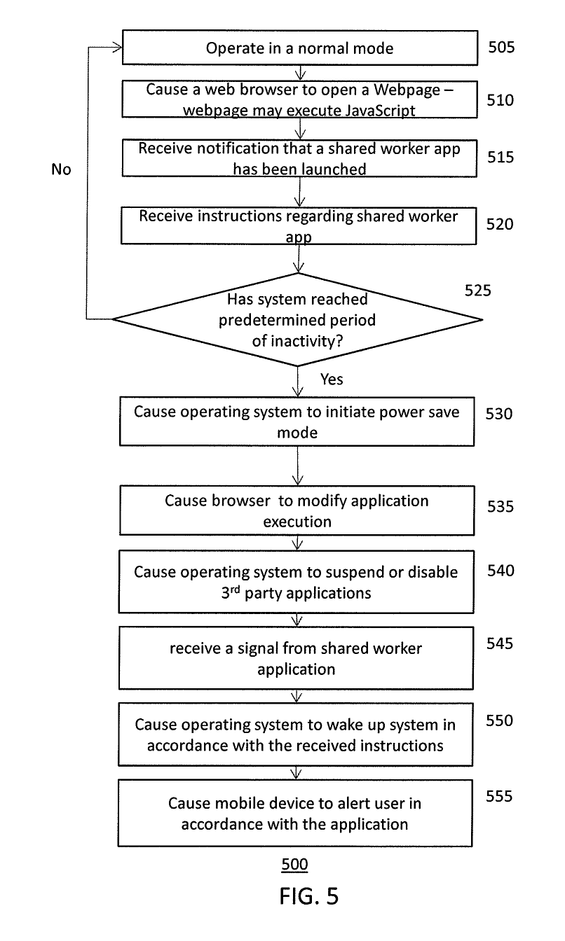

Referring now to FIG. 5, a flow chart is depicted that illustrates operations performed, such as by the apparatus 20 of FIG. 2, in accordance with an example embodiment of the present invention. As shown in block 505 of FIG. 5, the apparatus 20 embodied by the computing device 10 may therefore be configured to operate in a normal mode. The apparatus embodied by the computing device therefore includes means, such as the processor 22, the communication interface 26 or the like, for operating in a normal mode. By way of example in which the computing device 10 is a mobile telephone operating a version iOS or Android, a normal operating mode may be defined by all the functions of the device being available and operational.

In this embodiment, the apparatus 20 embodied by the computing device 10 may also be configured to cause a web browser to open an application, as shown in block 510 of FIG. 5. Thus, the apparatus may include means, such as the processor 22 or the like, for causing a web browser to open an application. In one embodiment, the application may be a web page being opened by a web browser. In another embodiment, the application may be an “app”, such as computer software application that is coded in a browser-supported programming language (such as JavaScript™, combined with a browser-rendered markup language like HTML5, reliant on a common web browser to render the application executable). In another embodiment of the invention, the application may be a privileged web application or privileged web app.

The apparatus 20 embodied by the computing device 10 may also be configured to receive notification that a shared worker application has been launched by the app or the web page. See block 515 of FIG. 5. Thus, the apparatus may include means, such as the processor 22 or the like, for causing reception of a notification that a shared worker application has been launched by the app or the web page. In one embodiment of the present invention, the shared worker application may comprise at least one event listener. For example, a restaurant app may launch a shared worker application that listens to location changes.

The apparatus 20 embodied by the computing device 10 may also be configured to receive notification of instructions regarding the shared worker. See block 520 of FIG. 5. Thus, the apparatus may include means, such as the processor 22 or the like, for causing reception of a notification of instructions regarding the shared worker. In one embodiment, the instructions may comprise information that a shared worker application is to continue running during a power savings mode and/or not to be disabled, paused, or modified.

The apparatus 20 embodied by the computing device 10 may also be configured to determine if the computing device has reached a predetermined period of inactivity. Thus, the apparatus may include means, such as the processor 22 or the like, for causing the determination of whether the computing device 10 has reached a predetermined period of inactivity. See block 525 of FIG. 5. If the determination concludes that the mobile device 10 has not reached the predetermined time of inactivity, the mobile device 10 continues to operate in a normal mode. If however, determination is made that the mobile device has reached a predetermined period for inactivity, a power save mode may be initiated.

In a case where a predetermined period of inactivity is has been reached, the apparatus 20 embodied by the computing device 10 may also be configured to initiate a power savings mode. See block 530 of FIG. 5. Thus, the apparatus may include means, such as the processor 22 or the like, for causing the initiation of a power savings mode. In one embodiment, the power savings mode may be to dim or darken the display screen. In alternative embodiments, the power savings mode may turn off the display screen or disable wireless functionality.

The apparatus 20 embodied by the computing device 10 may also be configured to modify, disable, or pause the execution of first application. See block 535 of FIG. 5. Thus, the apparatus may include means, such as the processor 22 or the like, for causing modification, disabling, or pausing of the execution of the first application.

The apparatus 20 embodied by the computing device 10 may also be configured to suspend or disable JavaScript execution. See block 540 of FIG. 5. Thus, the apparatus may include means, such as the processor 22 or the like, for causing suspension of disabling of JavaScript execution.

The apparatus 20 embodied by the computing device 10 may also be configured to receive a signal from the shared worker application. See block 545 of FIG. 5. Thus, the apparatus may include means, such as the processor 22 or the like, for causing reception of a signal from the shared worker application. In one embodiment, the shared web worker comprises at least one event listener. In one embodiment, when a specified event occurs, a specific action is triggered. In another embodiment, when an event specified by the event listener is triggered, the shared web worker may send a signal to the operating system. In another embodiment of the present invention, the shared web worker may run rudimentary logic to determine whether or not to wake the main execution of JavaScript. For example:

```
geofenceController.listen(function( ) {
      if (newDistanceMiles > 3)
            system.wakeup( );
});
```

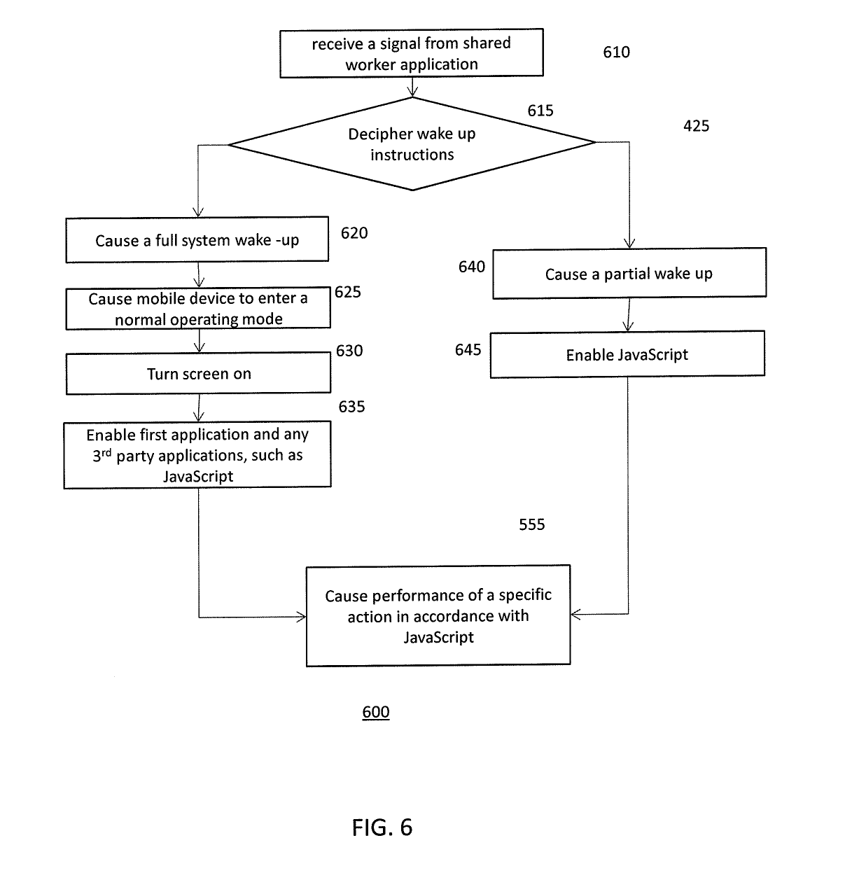

The apparatus 20 embodied by the computing device 10 may also be configured to cause the operating system to wake up. See block 550 of FIG. 5. Thus, the apparatus may include means, such as the processor 22 or the like, for causing the operating system to wake up. FIG. 6 shows the process of causing the system to wake up in more depth. In one embodiment, the system is caused to implement a full wake up. In an alternative embodiment, the system undergoes a partial wake up, where some features such as JavaScript are enabled, while other power savings actions continue.

The apparatus 20 embodied by the computing device 10 may also be configured to cause the mobile device to alert a user in accordance with instructions from the now normally operating first application. See block 555 of FIG. 5. Thus, the apparatus may include means, such as the processor 22 or the like, for causing the performance of a specific action. In one embodiment, the specific action is an audio alert. In another embodiment, the specific action may be a visual alert, such as a blinking light.

Referring now to FIG. 6, a flow chart 600 is provided illustrating operations related to the reception of the signal from the shared worker application and the plurality of different methods in which a wake up may be performed, such as by the apparatus 20 of FIG. 2. In accordance with an example embodiment of the present invention, the apparatus 20 embodied by the computing device 10 may also be configured to receive a signal from a shared worker application in response to a triggering event. The signal may include instructions for implementing a wake up function. See block 610 of FIG. 6. Thus, the apparatus may include means, such as the processor 22 or the like, for causing the reception of a signal from a shared worker application in response to a triggering event.

The apparatus 20 embodied by the computing device 10 may also be configured to decipher the wake up instructions received in the wake up instructions received from the shared worker application. See block 615 of FIG. 6. Thus, the apparatus may include means, such as the processor 22 or the like, for causing deciphering of the wake up instructions received in the wake up instructions received from the shared worker application.

If the deciphering of the wake up instructions determines that the signal from the shared worker application instructed a full system wake up, the apparatus 20 embodied by the computing device 10 may also be configured to send a signal to the operating system instructing a full system wake up. See block 620 of FIG. 6. Thus, the apparatus may include means, such as the processor 22 or the like, for causing a full system wake up.

The apparatus 20 embodied by the computing device 10 may also be configured to cause the computing device 10 to enter back into a normal operating mode. See block 625 of FIG. 6. Thus, the apparatus may include means, such as the processor 22 or the like, for causing the computing device 10 to enter into a normal operating mode.

The apparatus 20 embodied by the computing device 10 may also be configured to turn the display screen on. See block 630 of FIG. 6. Thus, the apparatus may include means, such as the processor 22 or the like, for causing the display screen to turn on.

The apparatus 20 embodied by the computing device 10 may also be configured to enable the first application and any third party applications. See block 635 of FIG. 6. Thus, the apparatus may include means, such as the processor 22 or the like, for causing the enablement of the first application and any third party applications. In one embodiment, the first application may be a web page or web application written in HTML5. The web page or web application may utilize one or more JavaScript applications. Here, both the web page or web application and the corresponding JavaScript will be enabled, and will thus, execute normally. With the web application or web page fully enabled, the process may now cause the performance of a specific action, as shown in block 555 of FIG. 5.

Referring back now to the deciphering operation, if the deciphering of the wake up instructions determines that the signal from the shared worker application instructed a partial system wake up, the apparatus 20 embodied by the computing device 10 may also be configured to cause a partial system wake up. See block 640 of FIG. 6. Thus, the apparatus may include means, such as the processor 22 or the like, for causing a partial system wake up. In one embodiment of the present invention, as shown in block 645 of FIG. 6, a partial system wake up may include enabling JavaScript and the specific action from block 555 of FIG. 5. In this case, the screen may remain off to keep conserving power and an audio alarm may sound to alert the user of the triggering event.

As described above, FIGS. 4, 5 and 6 illustrate flowcharts of an apparatus, method, and computer program product according to example embodiments of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 24 of an apparatus 20 employing an embodiment of the present invention and executed by a processor 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
executing a first application on a computing device;
launching a shared worker application, by the first application,;
informing the operating system, by the first application, of power saving mode instructions for the shared worker application;
running the shared worker application in accordance with power saving mode instructions when a power savings mode is enabled;
in response to a trigger, causing the shared worker application to send a signal to the operating system comprising wake up instructions; and
causing performance of a specific action by the computing device in response to the wake up instructions.

2. The method according to claim 1, further comprising disabling JavaScript execution in the power saving mode.

3. The method according to claim 1 wherein the shared worker application comprises at least one event listener.

4. The method according to claim 1 further comprising turning off a screen of the computing device in the power saving mode.

5. The method according to claim 1 wherein the wake up instructions instruct the operating system to return the computing device to a normal operating mode.

6. The method according to claim 1 wherein the wake up instructions instruct the operating system to return the first application to a normal operating mode.

7. The method according to claim 1, wherein the wake up instructions instruct the operating system to wake up only JavaScript and the specific action.

8. An apparatus comprising at least one processor and at least one memory including computer program code, the at least one memory and the computer program code configured to, with the processor, cause the apparatus to at least:
execute a first application on a computing device;
launching a shared worker application, by the first application;
inform the operating system, by the first application, of power saving mode instructions for the shared worker application;
run the shared worker application in accordance with power saving mode instructions when a power savings mode is enabled;
in response to a trigger, cause the shared worker application to send a signal to the operating system comprising wake up instructions; and
cause performance of a specific action by the computing device in response to the wake up instructions.

9. An apparatus according to claim 8 wherein the at least one memory and the computer program code are further configured to, with the processor, cause the apparatus to disable JavaScript execution in the power saving mode.

10. An apparatus according to claim 8 wherein the shared worker application comprises at least one event listener.

11. An apparatus according to claim 8 wherein the at least one memory and the computer program code are further configured to, with the processor, cause the apparatus to turn off a screen of the computing device in the power saving mode.

12. An apparatus according to claim 8 wherein the wake up instructions instruct the operating system to return the computing device to a normal operating mode.

13. An apparatus according to claim 8 wherein the wake up instructions instruct the operating system to return the first application to a normal operating mode.

14. An apparatus according to claim 8 wherein the wake up instructions instruct the operating system to wake up only JavaScript and the specific action.

15. A computer program product comprising at least one non-transitory computer-readable storage medium having computer-executable program code portions stored therein, the computer-executable program code portions comprising program code instructions for:
executing a first application on a computing device;
launching a shared worker application, by the first application;
informing the operating system, by the first application, of power saving mode instructions for the shared worker application;
running the shared worker application in accordance with power saving mode instructions when a power savings mode is enabled;
in response to a trigger, causing the shared worker application to send a signal to the operating system comprising wake up instructions; and
causing performance of a specific action by the computing device in response to the wake up instructions.

16. A computer program product according to claim 15 wherein the computer-executable program code portions further comprise program code instructions for disabling JavaScript execution in the power saving mode.

17. A computer program product according to claim 15 wherein the shared worker application comprises at least one event listener.

18. A computer program product according to claim 15 wherein the computer-executable program code portions further comprise program code instructions for turning off a screen of the computing device in the power saving mode.

19. A computer program product according to claim 15 wherein the wake up instructions instruct the operating system to return the computing device to a normal operating mode.

20. A computer program product according to claim 15 wherein the wake up instructions instruct the operating system to return the first application to a normal operating mode.

21. A computer program product according to claim 15 wherein the wake up instructions instruct the operating system to wake up only JavaScript and the specific action.
